(19) United States
(12) Patent Application Publication
(10) Pub. No.: US 2011/0084191 A1
(43) Pub. Date: Apr. 14, 2011

(54) HOLDER FOR A MOTOR VEHICLE ADD-ON PART AND DEVICE FOR HOLDING A MOTOR VEHICLE ADD-ON PART

(75) Inventor: Henry Lerchner, Hannover (DE)

(73) Assignee: Blaupunkt Antenna Systems GmbH & Co. KG, Hildesheim (DE)

(21) Appl. No.: 12/995,407

(22) PCT Filed: Nov. 17, 2008
(86) PCT No.: PCT/EP2008/065656

§ 371 Date: Dec. 21, 2010

(30) Foreign Application Priority Data
May 30, 2008 (DE) 10 2008 002 132.6

(51) Int. Cl. B60R 11/00; F16B 2/02

(52) U.S. Cl. 248/544

(57) ABSTRACT

The invention comprises a holder (1) for a motor vehicle add-on part for installation on a motor vehicle body part (3) which is provided with a receiving opening (2). In this case, one of the supporting elements (4, 5) forms a first supporting element (4) which is of rigid design, is mounted rotatably about an axis of rotation (10) and, over the circumference thereof, which runs around the axis of rotation (10), has a plurality of supporting surfaces (12) which are separated from one another, wherein the outer contour of the first supporting element (4) is set back between the supporting surfaces (12) in the direction of the axis of rotation (10). Furthermore, the invention comprises a device for holding a motor vehicle add-on part.

The invention relates to a holder for a motor vehicle add-on part for installation on a motor vehicle body part which is provided with a receiving opening, with two supporting members assigned to opposite sides of the vehicle body part which can be clamped onto each other by means of a tensioning device. The invention also comprises a device for holding a motor vehicle add-on part.

### PRIOR ART

Holders for a motor vehicle add-on part of the type mentioned above are known in the art, e.g. from DE 102 10 628, DE 102 10 593 or EP 1 329 978. They are used to fix a motor vehicle add-on part to a motor vehicle body part. Multi-part holding devices are often used for this purpose. These make it necessary for a first part of the holding device to be accommodated and secured in a receiving opening in the body part in the first instance. In a subsequent stage, a second part which is intended to secure the first part definitively is then positioned on a second side of the body part and fixed to the first part of the holding device. This can be achieved by any fixing device, e.g. a screw connection. Clamping devices with spring or resilient members are also frequently used for fixing purposes and these can lose their resilience over time or cause problems during dismantling. Force from the clamping device is often not transmitted directly, but by expanding the resilient member, for example. In this version of the fixing device, the two parts of the holding device cannot be moved any distance towards each other and the body part clamped between them. Fixing is more likely to be achieved merely by expanding the resilient members in an opening in the body part, thus providing just a small contact surface—i.e. the surface of the opening in the body part—for clamping the add-on part. This means that it is necessary to adjust the holder to the respective body part, which means that it cannot be used universally, for example across different motor vehicle design series. A version with a clamping device may possibly also make it necessary to select a multi-part version in which the tensioning device, e.g. a screw, is only assembled after inserting the holder into the receiving opening of the body part. The requirement described in DE 102 10 593 to provide special plastics for the clamping device is also a disadvantage. The clamping device is exposed to not inconsiderable forces which standard plastics might not be able to withstand. When using an expandable clamping device, the designer is also subject to additional restrictions with regard to the size and shape of the holder. It is clear that a clamping device expanded by a screw, for example, cannot be constructed to be of any desired diameter. The shape of the clamping device must also usually be adjusted to the shape of a fixing device, i.e. usually a screw, and is thus at least approximately circular.

### DISCLOSURE OF THE INVENTION

The holder for a motor vehicle add-on part according to the invention does not have the described disadvantages. In particular, it is in a single piece and can easily be assembled by one person without any difficulty. The supporting members and tensioning device do not impose any particular requirements with respect to the material. Direct force transmission from the tensioning device to the holder is a particular feature. The holder according to the invention is characterised in that one of the supporting members forms a first supporting member which is of rigid design, mounted rotatably around an axis of rotation and with a plurality of supporting surfaces which are separate from each other over the circumference of the supporting member around the vertical axis, the outer contour of the first supporting member being set back between the supporting surfaces in the direction of the vertical axis. This means that the supporting members move towards each other during a clamping action of the tensioning device and hold areas of the body part between them. In this process the tensioning device can be tensioned until a sufficiently tight fit, in particular by means of an interference fit, of the body part between the supporting members is achieved. One of the supporting members is designed to be rigid, i.e. not yielding, during this process. It thus merely has a small degree of resilience. It is also mounted rotatably around an axis of rotation such that it can be rotated with respect to the other supporting member, in other words can be placed in a different angular position. The supporting member comes into contact with the body part by means of supporting surfaces, with several supporting surfaces being separate from each other and distributed along a circumference running around the vertical axis. The outer contour of the supporting member can be designed to be continuous, but is set back in the direction of the vertical axis in areas in which there are no supporting surfaces. This results in recesses in the supporting member between the supporting members. A recess designed for the holder is provided in the body part. This means that the recess is designed such that the first supporting member can be moved through the opening and thus reach the side of the body part assigned to this supporting member, and such that the second supporting member cannot be moved through the recess due to its dimensions, but remains on its allocated side of the body part. The recess is in particular formed such that the first supporting member can be moved through the recess first and then rotated around an axis of rotation. After this rotation, the supporting surfaces of the first supporting member are no longer positioned above the recess, with the result that the supporting surfaces are placed upon the body part and fix the first supporting member to the side of the body part allocated to this supporting member. In a subsequent stage, the supporting members are moved towards each other by means of the tensioning device, causing the first supporting member and the supporting surfaces of the second supporting member to come into contact, and in particular pressure contact, with the side of the body part allocated to these surfaces. The supporting members are moved towards each other with the tensioning device until the supporting members are held securely against the body part.

A development of the invention provides that the first supporting member is designed as a support claw with a plurality of claw arms. In this case at least one claw arm is provided, but the support claw can also have any number of claw arms. The support claw is, for example, designed such that the claw arms initially run horizontally outwards in a radial direction and are then bent vertically in the direction of the second supporting member. In this case the angle of the bend can be selected according to the desired flexibility of the supporting member. Thus, for example, only a low level of flexibility is provided by a bend of 90°, whereas the spring effect is greater with an angle which is less than 90°.

Another development of the invention provides that the supporting surfaces are located at the ends of the claw arms. It is also possible for a claw arm to have a plurality of supporting surfaces.

Another development of the invention provides that the support claw is designed in the shape of a star. A star shape is advantageous insofar as the claw arms are distributed evenly over the circumference of the support claw. For example, a version with four claw arms may be provided in which two claw arms are diametrically opposite each other and one claw arm pair is rotated through an angle of 90° with respect to the other claw arm pair. However, as a general rule, versions of the support claw with any number of claw arms in various positions are possible.

Another development of the invention provides that the other supporting member forms a second supporting member with at least one contact surface. For example, it is possible for the second supporting member not to be in contact with the motor vehicle body part over its entire surface, but merely via its contact surface. There may be a certain distance between the second supporting member and the body part as a result of the contact surface. It is particularly advantageous if the contact surfaces of the second supporting member are located such that they are opposite the supporting surfaces of the first supporting member or on the opposite side of the body part. If there is a distance between the second supporting member and the body part, this can prevent the body part from deforming due to the force applied by the tensioning device. This means that as many contact surfaces as supporting surfaces are preferably present. However it is also possible that the contact surface may assume a different shape, for example an uninterrupted ring, or may not be constructed opposite the supporting surfaces.

Another development of the invention provides that the second supporting member is allocated to an initial latch to hold it in a receiving opening. The holder is held securely in the receiving opening by the initial latch during the assembly process, after passing the second supporting member through the receiving opening, but before the tensioning device clamping process. Therefore, the holder is first placed in the receiving opening until the initial latch creates a latch connection between the second supporting member and the receiving opening or the body part surrounding the receiving opening. The first support member can then be turned and the two supporting members moved towards each other by means of the tensioning device and thus tensioned.

Another development of the invention provides that the initial latch has at least one spring latch. The spring latch preferably has a projection which engages with the back of the body part and thus produces a latch connection or an initial latch respectively between the body part and the second supporting member. The spring latch preferably has an inclined surface and a spring effect. While the holder is being placed in the receiving opening, the inclined surface comes into contact with an edge of the receiving opening, causing the spring latch to be deflected by spring action. This guarantees ease of insertion. If the second supporting member is then placed in the receiving opening such that the edge of the receiving opening lies behind the projection, the spring latch is pressed back in the direction of the edge thanks to its spring action, causing the spring latch or the projection of the spring latch to engage with the edge of the receiving opening and thus secure the holder in the receiving opening.

Another development of the invention provides that the tensioning device is a screw connection. The two supporting members can, for example, be connected together directly by means of the screw connection. This guarantees direct force transmission into the holder and thus a firm and permanent connection. In this case a screw connection is already provided in a delivered version of the holder, with the result that a pre-assembly stage is not required.

Another development of the invention provides that the first supporting member assumes a first angular position before an assembly operation and assumes a second angular position, different from the first angular position, after the assembly operation. In particular, it is provided that the first supporting member can be moved through the receiving opening in the body part in the first angular position, whilst in the second angular position the supporting member is positioned such that it is prevented from moving out of the receiving opening. For example, the first supporting member can be turned manually from the first angular position into the second angular position, i.e. by hand by the fitter.

Another development of the invention provides that the first supporting member can be rotated into the second angular position by the tensioning device. This means that the first supporting member turns into the second angular position as soon as the tensioning device is actuated. In this operation, the rotation can come about as a result of movement of the tensioning device, in particular a screw, and also as a result of rotation of the tensioning device. This makes it simple and quick to assemble with a limited number of operating stages.

Another development of the invention provides that the first supporting member can be engaged in the first and second angular positions by means of a latching device. So as to prevent the first supporting member turning too easily and thus unintentionally, a latching device is provided which holds the first supporting member in the first or second angular position. In this process, it is provided that a latch connection on the latching device is released if a certain level of force is applied. In other words, the first supporting member is released from a latched position in the first and/or second angular position and can then be turned freely for the time being. If the first or second angular position is reached after turning, the first supporting member engages with the latching device again so that the new angular position is maintained for the time being.

The invention also relates to a device for holding a motor vehicle add-on part with a holder, preferably according to the above versions, and with a motor vehicle body part, in which the body part has a non-rotationally-symmetrical receiving opening, in which the holder has a rotatably mounted supporting member which can fit through the receiving opening in a first angular position and is supported on an edge region of the receiving opening in a second angular position. The receiving opening is designed such that the first supporting member can be moved through the receiving opening in the first angular position, but not in the second angular position. This is achieved by the fact that it is designed to be non-rotationally-symmetrical. For example, a substantially polygonal form is provided. In this way, the shape of the receiving opening is adjusted to the outer contour of the first supporting member. Recesses with a minimal depth may advantageously be provided in the body part at those areas of the body part at which the supporting surfaces of the first supporting member are located in the second angular position in order to secure the supporting members against displacement.

Another development of the invention provides that the receiving opening is designed as a polygonal, and in particular a quadrilateral hole.

### BRIEF DESCRIPTION OF THE DRAWINGS

The drawings clarify the invention with reference to an embodiment of the invention. In the drawings:

FIG. 1 is a perspective view of a holder for a motor vehicle add-on part with two supporting members and a tensioning device before assembly,

FIG. 2 shows a first supporting member for the holder in the form of a support claw with a guide device,

FIG. 3 shows the support claw,

FIG. 4 shows the guide device,

FIG. 5 shows a second supporting member for the holder,

FIG. 6 shows the holder for a motor vehicle add-on part after assembly on a motor vehicle body part.

### EMBODIMENT(S) OF THE INVENTION

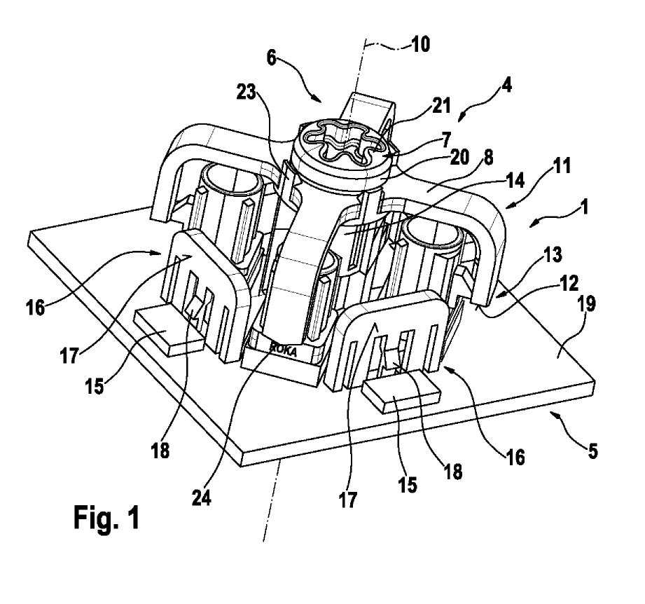

FIG. 1 shows a holder 1 for fixing a motor vehicle add-on part to a motor vehicle body part 3, which is not shown here, which has a receiving opening 2 which is likewise not illustrated. The holder 1 is composed of two supporting members 4 and 5, where reference numeral 4 refers to a first supporting member and reference numeral 5 refers to a second supporting member. The supporting members 4 and 5 can be moved towards each other and clamped against each other by means of a tensioning device 6 which is designed as a screw connection 7 in this case. The first supporting member 4 is designed as a support claw 8. This has a plurality of claw arms 9, in this case four, which are designed to be rigid. They initially run outwards in a radial direction with respect to an axis of rotation 10 for the first supporting member 4 before they are curved in a bending position 11 which is preferably similar for all claw arms 9 and then run in the direction of the second supporting member 5. In this operation, a bending angle at the bending position 11 can be selected at random, with an angle of 90° being shown here. The first supporting member 4 has supporting surfaces 12 which are provided at the ends 13 of the claw arms 9 in this case. The first supporting member 4 is mounted rotatably around the axis of rotation 10 with respect to the second supporting member 5. It is guided in this operation by means of a guide member 14. The second supporting member 5 has contact surfaces 15 which are distributed over the circumference. Four contact surfaces 15 are provided in the example shown here. The second supporting member 5 also has an initial latch 16 which may have a guide surface 17 and at least one spring latch 18. The contact surfaces 15 and the initial latch 16 are located on a base plate 19.

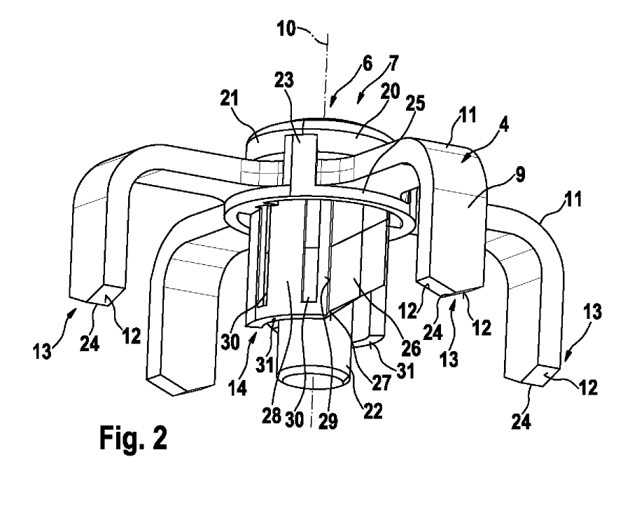

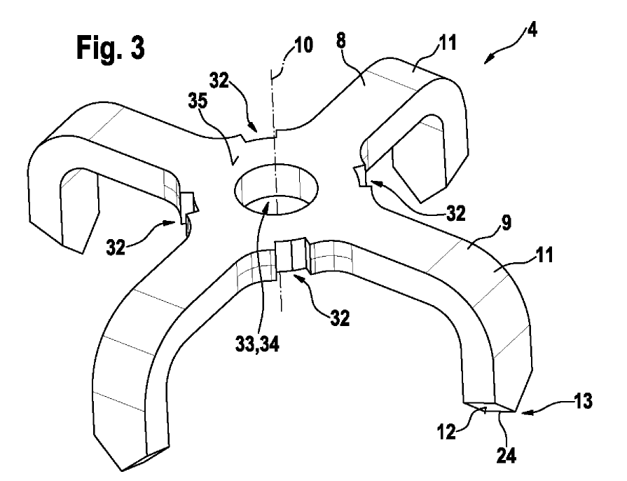

FIG. 2 shows the first supporting member 4, the guide member 14 and a screw 20 for the screw connection 7. The screw 20 has a head 21 on one of its sides, whilst a thread 22 is provided on the other side. The screw 20 passes through both the first supporting member 4 and the guide member 14 and has a greater elongation in the vertical direction than the combination of both members 4 and 14. It is clear that the first supporting member 4 is prevented from moving with respect to the guide member and in an axial or radial direction by means of latches 23 on the guide member 14. The first supporting member 4 is simultaneously prevented from rotating with respect to the guide member 14 as described below and shown in FIG. 3. The latches 23 are designed to be resilient, with the result that the first supporting member 4 can simply be engaged in or clipped into the latches 23 of the guide member 14. The supporting surfaces 12 which are provided at the end 13 of the claw arms 9 can be angled towards each other, thus forming a contact edge 24. It is clear that the first supporting member 4 is substantially designed in the form of a star-shaped support claw 8. In other embodiments, however, a different number of claw arms 9 or a different orientation of the claw arms 9 can be used without any problems. Likewise, it is not necessary for the claw arms 9 to be distributed evenly over the circumference of the first supporting member 4. The guide member 14, which is fixed to the first supporting member 4 via the latches 23, has a substantially circular shape in this embodiment, and the largest diameter is formed by a retaining ring 25 in this case. The latches 23 are formed on this retaining ring 25. A lowering guide 26 with a lowering guide surface 27 is provided beneath the retaining ring 25. The lowering guide surface 27 is angled with respect to the guide member 14 or its retaining ring 25. A plurality of lowering guides 26 are provided over the circumference of the guide member 14 and these are also substantially circular in circumference, but do not necessarily have a continuous circumference. Turning guides 28 are located adjacent to the lowering guide 26, and these are set back in the circumference with respect to the lowering guide. Turning end stop surfaces 29 are formed by the diameter set back from the lowering guide 26 at a transition point between the lowering guide 26 and the turning guide 28. In addition to the turning end stop surfaces 29, the turning guide 28 also has turning latch positions which are formed by turning latch recesses 30. Vertical end stop surfaces 31 are also located on the first supporting member 4 and in this case these are positioned on the underside of the turning guide 28.

FIG. 3 shows a detailed view of the first supporting member 4 which is designed as a support claw 8. In addition to the above embodiments, the drawing shows that the support claw 8 has latch recesses 32 at positions between the claw arms 9, i.e. positions at which an outer contour of the first supporting member 4 is set back towards the axis of rotation 10 and the latches 23 on the guide member 14 can be engaged in these recesses. The first supporting member 4 and the guide member 14 can thus be engaged such that they do not rotate with respect to each other. The support claw 8 also has a central, circular recess 33, in this case a hole 34, into which the screw 20 can be inserted. The diameter of the hole 34 or recess 33 more or less corresponds to the diameter of the screw 20. A surface of the support claw 8 adjacent to the hole 34 forms a contact surface 35 with which the head 21 of the screw 20 can come into surface contact with the screw connection 7 belonging to the tensioning device 6. It is clear that the outer circumference of the first supporting member 4 runs substantially continuously with the exception of the latch recesses 32 and the ends 13 of the claw arms 9. However, a different shape can also be provided, in particular a shape in which the forces applied to the contact edge 24 are ideally distributed within the first supporting member 4.

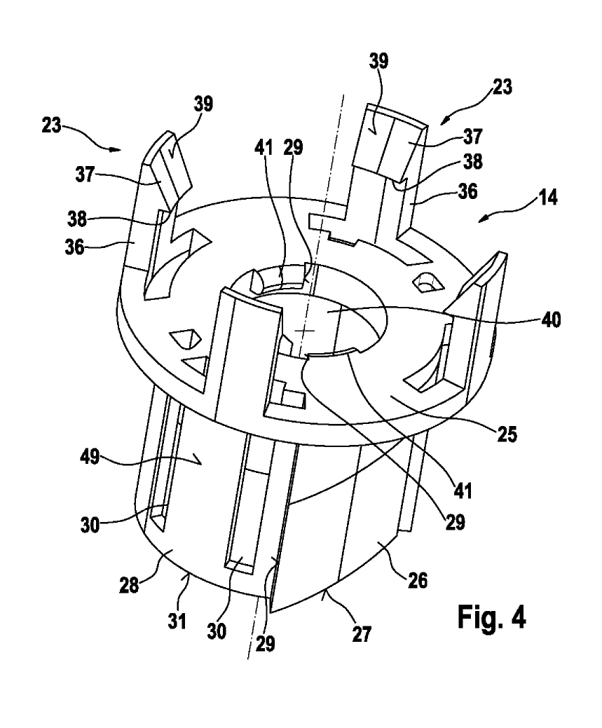

FIG. 4 shows a detailed view of the guide member 14. In particular it shows the latches 23 which are used to engage the guide member 14 with the first supporting member 4, i.e. the support claw 8. The latches 23 are positioned distributed around the circumference of the retaining ring 25. In this process they may define the outermost circumference of the retaining ring 25, as shown. They have a resilient latching body 36 and a latching tongue 37. The latching tongue 37 forms a latching projection 38 since it is thicker in one area adjacent to the latching body 36. The latching tongue 37 tapers, for example continuously as shown in this case, in the direction of the freestanding end of the latch 23 in such a way as to form an inclined engaging surface 39. The lowering guide 26 and the turning guide 28 are provided at a lower end of the guide member 14, as already described for FIG. 2. In addition to the turning stop surface 29 of the turning guide 28, an additional turning end stop device 41 is provided in a central circular recess 40. This has other turning end stop surfaces 29. The recess 40 may have a substantially larger diameter than the recess 33 in the first supporting member 4. At the very least, it has a radial thickness which at least corresponds to a diameter of the screw 20 minus the thickness of the turning end stop device 41.

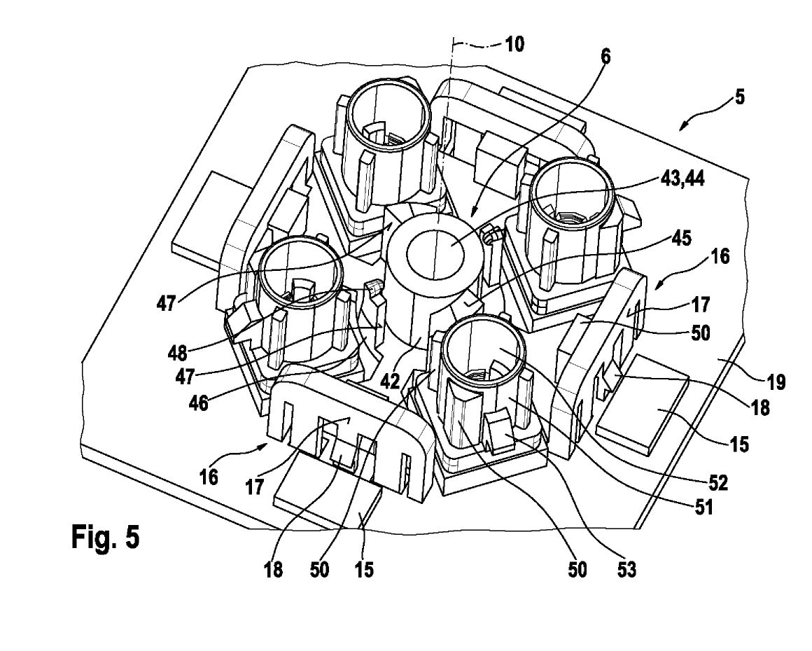

FIG. 5 shows an enlarged detailed view of the second supporting member 5, but only shows a section of the latter. The centrally positioned tensioning device 6 which, in the case of the second supporting member 5, is characterised by a receiving member 42 for the screw connection 7 can be clearly seen. The receiving member 42 is positioned substantially centrally and has a recess 43 with an internal thread 44 in its centre, in which the thread 22 of the screw can engage. Vertical guide surfaces 45 which interact with the vertical end stop surfaces 31 are also provided on the receiving member 42. These are inclined at an angle to the surface of the second supporting member 5, which substantially corresponds to an angle of the lowering guide surface 27 with respect to the guide member 14. The receiving member 42 has an outer diameter which substantially corresponds to an internal diameter of a lower part of the guide member 14 or an internal diameter of the lowering guide 26 and/or the turning guide 28. A turning guide counter member 46 is positioned at a distance from the receiving member 42 which substantially corresponds to a thickness of the turning guide 28. This has at least one turning end stop counter surface 47 which can be connected or come into contact with the turning end stop surface 29. In addition, a turning latch 48 is provided on the turning guide counter member 46 which can be engaged in the turning latch recesses 30. To this end, the turning guide counter member 46 is designed to be resilient so that the turning latch 48 can both run on a surface 49 of the turning guide 28 (see FIG. 4) and engage and latch in the turning latch recesses 30. Both the receiving member 42 and the turning guide counter member 46 are located on the base plate 19 of the second supporting member 5. As already explained for FIG. 1, contact surfaces 15 and initial latches 16 with guide surfaces 17 and latches 18 are also provided on this base plate 19. In order to increase the strength of the initial latch 16, stiffening members 50 can be provided which, for example, are positioned behind the initial latch 16 and increase the stability and stiffness of the initial latch 16. Furthermore, guide devices 51 are provided on the base pate 19, which, for example, have a recess 52 passing through the base plate 19. This recess 52 may, for example, be used as a connector or to guide cables. Latching devices 53 are provided on the guide devices 51 and these latching devices can be used to clip a motor vehicle add-on part which is not illustrated onto the holder 1 or the second supporting member 5 respectively and engage it with the latter. Like the latches 23 on the guide member 14, the latching devices 53 have an inclined surface and a latch projection which guarantee that the motor vehicle add-on part can be slipped on easily and securely latched in position. In order to increase the stability of the guide devices 51, stiffening members 50 can also be provided in this case. It is also conceivable that these stiffening members 50 on the guide device 51 will assume a guide function with respect to the motor vehicle add-on part and prevent this from being displaced in a radial direction for example.

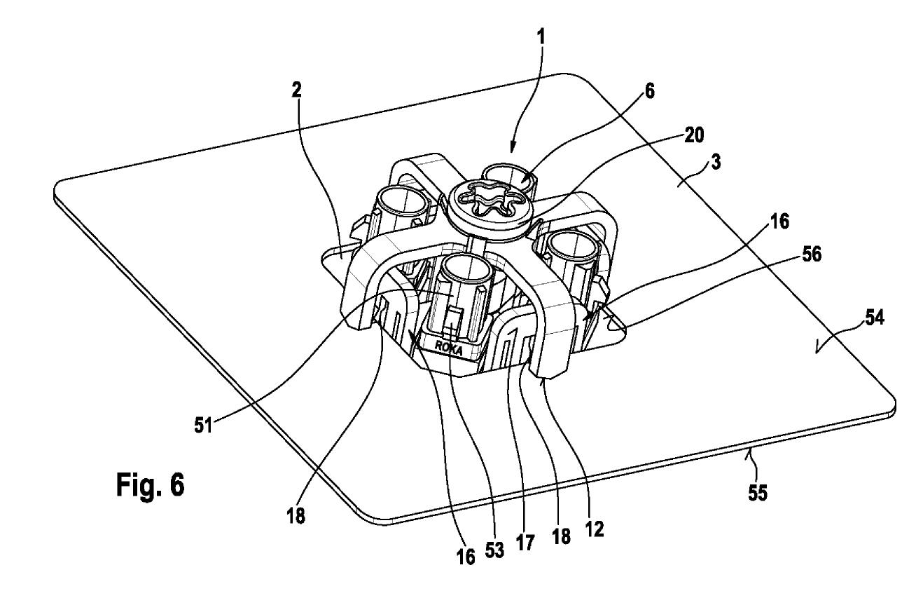

FIG. 6 shows the holder 1 in its assembled position on a body part 3 which is shown in section in this instance. It is evident that the first supporting member 4 or the support claw 8 is now in a second angular position. In this position, the supporting surfaces 12 are ideally opposite the contact surface 15, which is located beneath the body part 3 in FIG. 6 and thus cannot be seen. In this assembled position the spring latches 18 of the initial latch 16 grip over the upper edge of the body part 3 and ensure that the holder 1 is initially fixed in the receiving opening 2 of the body part 3. The holder 1 can be definitively fixed in position when the first supporting member 4 is tensioned against the second supporting member 5 with the aid of the tensioning device 6. In the assembled position, as shown in FIG. 6, the screw 20 is tightened, causing the supporting surfaces 12 or the contact edges 24 to move towards the body part 3, thus ensuring tensioning.

A brief description of the functions during assembly is given below. FIG. 1 (before assembly) and FIG. 6 (assembled position) are used for this purpose. As shown in FIG. 1, the first supporting member 4 of the holder 1 or the support claw 8 is first turned through 45° with respect to the second supporting member 5 around the axis of rotation 10. This means that the supporting surfaces 12 are not positioned above the contact surfaces 15, but are at a certain distance from these surfaces. In this state, a delivery state, in which the first supporting member 4 is fixed to the second supporting member 5 by means of the tensioning device 6, the holder 1 can be inserted into the receiving opening 2. In this operation the first supporting member 4 is moved through the receiving opening 2 until the contact surfaces 15 on one side of the body part 3 come into contact, specifically surface contact, with its second surface 55. During the insertion process the resilient spring latches 18 of the initial latch 16 are pressed radially inwards and are able to release outwards again by resilient means as soon as the holder 1 reaches a sufficient insertion depth in the receiving opening 2 of the body part 3. This ensures initial fixing of the holder 1 in the receiving opening 2, as the holder 1 can now no longer be easily released from the receiving opening 2. The tensioning device 6 is then used to achieve definitive fixing. The screw 20 is turned for this purpose. This causes a translational movement of the first supporting member 4 towards the second supporting member 5 as these are moved towards each other by the screw 20. As the lowering guide surface 27 lies on the vertical guide surface 45, a rotational movement of the guide member 14 must be used to permit the vertical movement of the tensioning device 6. This rotation movement of the guide member 14 also causes a rotation movement of the support claw 8 secured to this guide member or the first supporting member 4. Lowering guide surfaces 27 and vertical surfaces 45 are designed such that the first supporting member describes a turning movement such that the supporting surfaces 12 are positioned over the contact surfaces 15. Once this state is reached, a further translational movement of the first supporting member 4 towards the second supporting member 5 does not lead to a further turning movement. The turning stop surfaces 29 are provided for this purpose, these being in contact with the turning end stop counter surfaces 48 from this point and preventing any further rotation. The same applies to the turning stop device 41 which was moved towards a turning end stop counter surface 47 and is now in contact with this surface. To prevent the first supporting member 4 turning by mistake prior to assembly, turning latches 48 are provided which are engaged in a first angular position in one of the latch recesses 30. The turning latch 48 can emerge from the turning latch recess 30 by applying a certain amount of force during the rotation movement and then run along a surface 49 of the turning guide 28 until the second turning latch recess 30 is reached. The turning latch 48 engages in this recess in turn. This will be the case on completion of the rotation movement, i.e. usually when turning the first supporting member 4 through 45° with respect to the second supporting member 5. The contact between the turning end stop surface 29 and the turning stop counter surface 47 thus prevents any further turning of the first supporting member 4 and turning back too easily is prevented by the turning latch 48 being engaged in the turning latch recess 30. After initial tensioning with the aid of the tensioning device 6, i.e. moving the first supporting member 4 towards the second supporting member 5, the rotation movement of the first supporting member 4 is thus complete. From this moment there is merely a translational movement of the supporting members 4 and 5 towards each other caused by turning the screw 20 even more. As a result of this movement, the supporting surfaces 12 are moved onto the first surface 54 of the body part 3, whilst the contact surface 15 on the opposite side of the body part comes into contact with the second surface 55. After the rotation movement, the supporting surfaces 12 are ideally opposite the contact surface 15, as described. Tightening the screw 20 even more thus tensions the body part 3 between the supporting surfaces 12 and the contact surfaces 15 and thus securely fixes the holder 1 to the body part 3. The installation position shown in FIG. 6 is thus achieved. The motor vehicle add-on part (not shown) can then be fixed or clipped onto the holder 1 with the aid of the latching device 53 on the guide device 51. The guide surfaces 17 come into contact with the inner surfaces 56 of the receiving opening 3 in the installation position and prevent the holder 1 being displaced in the radial direction in addition to tensioning the supporting members 4 and 5. In this embodiment of the invention, the receiving opening 2 is designed as a polygonal hole, as in this case the first supporting member 4 is inserted through the diagonal of the receiving opening 2 in its first angular position, whilst the supporting surfaces 12 are connected to the first surface 54 of the body part 3 after a rotation movement of the first supporting member 4.

1. Holder (1) for a motor vehicle add-on part for installation on a motor vehicle body part (3) which is provided with a receiving opening (2), with two supporting members (4, 5) assigned to opposite sides of the vehicle body part (3) which can be clamped onto each other by means of a tensioning device (6), characterised in that one of the supporting members (4, 5) forms a first supporting member (4) which is of rigid design, mounted rotatably around an axis of rotation (10) and with a plurality of supporting surfaces (12) which are separate from each other over the circumference of the supporting member around the axis of rotation (10), the outer contour of the first supporting member (4) being set back between the supporting surfaces (12) in the direction of the axis of rotation (10).

2. Holder according to claim 1, characterised in that the first supporting member (4) is designed as a support claw (8) with a plurality of claw arms (9).

3. Holder according to one or more of the preceding claims, characterised in that the supporting surfaces (12) are located at the ends (13) of the claw arms (9).

4. Holder according to one or more of the preceding claims, characterised in that the support claw (8) is designed in the form of a star.

5. Holder according to one or more of the preceding claims, characterised in that the other supporting member (5, 4) forms a second supporting member (5) which has at least one contact surface (15).

6. Holder according to one or more of the preceding claims, characterised in that the second supporting member (5) is allocated to an initial latch (16) to hold it in a receiving opening (2).

7. Holder according to one or more of the preceding claims, characterised in that the initial latch (16) has at least one spring latch (18).

8. Holder according to one or more of the preceding claims, characterised in that the tensioning device (6) is a screw connection (7).

9. Holder according to one or more of the preceding claims, characterised in that the first supporting member (4) assumes a first angular position before an assembly operation and assumes a second angular position, different from the first angular position, after the assembly operation.

10. Holder according to one or more of the preceding claims, characterised in that the first supporting member (4) can be rotated into the second angular position by the tensioning device (6).

11. Holder according to one or more of the preceding claims, characterised in that the first supporting member (4) can be engaged in the first and second angular positions by means of a latching device.

12. Device for holding a motor vehicle add-on part with a holder (1), preferably according to one or more of the preceding claims, and with a motor vehicle body part (3), wherein the body part (3) has a non-rotationally-symmetrical receiving opening (2), the holder (1) having a rotatably mounted supporting member (4, 5) which can fit through the receiving opening (2) in a first angular position and is supported on an edge region of the receiving opening (2) in a second angular position.

13. Device according to claim 12, characterised in that the receiving opening (2) is designed as a polygonal, and in particular a quadrilateral hole.
